(19) United States
(12) Patent Application Publication
(10) Pub. No.: US 2020/0180569 A1
(43) Pub. Date: Jun. 11, 2020

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventor: Kwang Won SEO, Gunpo-si (KR)

(73) Assignees: HYUNDAI MOTOR COMPANY, Seoul (KR); KIA MOTORS CORPORATION, Seoul (KR)

(21) Appl. No.: 16/582,162

(22) Filed: Sep. 25, 2019

(30) Foreign Application Priority Data
Dec. 10, 2018 (KR) 10-2018-0158581

(51) Int. Cl. B60S 1/52; G01S 17/93; B60S 1/60; B60S 1/54

(52) U.S. Cl. CPC B60S 1/528; B60S 1/54; B60S 1/60; G01S 17/93

(57) ABSTRACT

A vehicle and a method of controlling the vehicle capable of removing contamination of a Light Detection and Ranging (LiDAR) surface mounted on the vehicle are provided. The vehicle may include: Light Detection and Ranging (LiDAR) configured to detect an object and a terrain around the vehicle; and a cleaning nozzle device configured to inject cleaning liquid and compressed air to a passage of laser pulses on a LiDAR surface.

### CROSS-REFERENCE TO RELATED APPLICATION(S)

The present application claims priority to and the benefit of Korean Patent Application No. 10-2018-0158581, filed on Dec. 10, 2018, which is incorporated herein by reference in its entirety.

### TECHNICAL FIELD

The present disclosure relates to a vehicle, and more particularly, to a vehicle provided with Light Detection and Ranging (LiDAR).

### BACKGROUND

The statements in this section merely provide background information related to the present disclosure and may not constitute prior art.

A Light Detection and Ranging (LiDAR) sensor is a technology that can detect the distance, direction, speed, temperature, material distribution and concentration characteristics to objects by irradiating a laser to a target. The LiDAR sensor generally utilizes the advantage of the laser that can generate pulse signals with high energy density and short periods, and is used for more precise observation of the physical properties of the atmosphere and distance measurement.

The LiDAR sensor technology was first attempted in the 1930s for the purpose of analyzing the air density in the sky through the scattering intensity of searchlight light. However, with the disclosure of the laser in the 1960s, full-scale development was possible. With the continuous development of laser light source technology since the 1970s, the LiDAR sensor technology that can be applied to various fields has been developed. The LiDAR sensor technology is used in aircraft, satellites, etc., and is used as an important observation technology for precise atmospheric analysis and global environment observation. In addition, the LiDAR sensor technology is used as a means to complement camera functions such as the distance measurement to objects by being mounted on spacecraft and exploration robots.

In recent years, the LiDAR sensor technology has been used to search the surroundings for autonomous driving of a vehicle. In other words, the LiDAR sensor is installed in the vehicle, and the position and distance of obstacles such as buildings, pedestrians, and other vehicles located in the vicinity of the vehicle are detected and used for autonomous driving of the vehicle.

### SUMMARY

One aspect of the present disclosure is to effectively remove contamination of a Light Detection and Ranging (LiDAR) surface mounted on a vehicle.

Additional aspects of the disclosure will be set forth in part in the description which follows and, in part, will be obvious from the description, or may be learned by practice of the disclosure.

In accordance with an aspect of the disclosure, a vehicle includes: Light Detection and Ranging (LiDAR) configured to detect an object and a terrain around the vehicle; and a cleaning nozzle device configured to inject cleaning liquid and compressed air to a passage of laser pulses on a LiDAR surface.

The cleaning nozzle device may include a cleaning liquid nozzle configured to inject the cleaning liquid and a compressed air nozzle configured to inject the compressed air.

The vehicle may further include: a sensor configured to detect a contamination degree of the LiDAR surface.

The vehicle may further include: a controller configured to generate, when the contamination degree detected through the sensor exceeds a predetermined reference value, a cleaning signal to perform a cleaning operation of the LiDAR surface.

The controller may classify the contamination degree of the LiDAR surface into a plurality of different contamination degrees according to a ratio of a laser point having a distance value less than or equal to a predetermined distance value among the laser points for one cycle of the LiDAR.

The cleaning operation may include a cleaning operation using only the compressed air when the contamination degree is a first contamination degree; a cleaning operation using only the cleaning liquid when the contamination degree is a second contamination degree higher than the first contamination degree; and a cleaning operation using both the cleaning liquid and the compressed air when the contamination degree is a third contamination degree higher than the second contamination degree.

In accordance with an aspect of the disclosure, a method of controlling a vehicle includes: detecting a contamination degree of a Light Detection and Ranging (LiDAR) surface to detect an object and a terrain around the vehicle; and injecting cleaning liquid and compressed air through a cleaning nozzle device to a passage of laser pulses on a LiDAR surface.

The cleaning nozzle device may include a cleaning liquid nozzle configured to inject the cleaning liquid and a compressed air nozzle configured to inject the compressed air.

The method may further include: a sensor configured to detect the contamination degree of the LiDAR surface.

The method may further include: generating a cleaning signal, when the contamination degree detected through the sensor exceeds a predetermined reference value, to perform a cleaning operation of the LiDAR surface.

The generating of the cleaning signal may include classifying the contamination degree of the LiDAR surface into a plurality of different contamination degrees according to a ratio of a laser point having a distance value less than or equal to a predetermined distance value among the laser points for one cycle of the LiDAR.

The cleaning operation may include a cleaning operation using only the compressed air when the contamination degree is a first contamination degree; a cleaning operation using only the cleaning liquid when the contamination degree is a second contamination degree higher than the first contamination degree; and a cleaning operation using both the cleaning liquid and the compressed air when the contamination degree is a third contamination degree higher than the second contamination degree.

In accordance with an aspect of the disclosure, a vehicle includes: Light Detection and Ranging (LiDAR) configured to detect an object and a terrain around the vehicle; a cleaning nozzle device including a cleaning liquid nozzle configured to inject cleaning liquid and a compressed air nozzle configured to inject compressed air, configured to inject the cleaning liquid and the compressed air through the cleaning liquid nozzle and the compressed air nozzle to a passage of laser pulses on a LiDAR surface; a cleaning liquid reservoir configured to store the cleaning liquid; a cleaning liquid motor configured to supply the cleaning liquid to the cleaning liquid nozzle; an air compressor configured to compress the air to generate the compressed air; a sensor configured to detect a contamination degree of the LiDAR surface; and a controller configured to generate, when the contamination degree detected through the sensor exceeds a predetermined reference value, a cleaning signal to perform a cleaning operation of the LiDAR surface.

The controller may classify the contamination degree of the LiDAR surface into a plurality of different contamination degrees according to a ratio of a laser point having a distance value less than or equal to a predetermined distance value among the laser points for one cycle of the LiDAR.

The cleaning operation may include a cleaning operation using only the compressed air when the contamination degree is a first contamination degree; a cleaning operation using only the cleaning liquid when the contamination degree is a second contamination degree higher than the first contamination degree; and a cleaning operation using both the cleaning liquid and the compressed air when the contamination degree is a third contamination degree higher than the second contamination degree.

In accordance with an aspect of the disclosure, a method of controlling a vehicle includes: detecting a contamination degree of a Light Detection and Ranging (LiDAR) surface to detect an object and a terrain around the vehicle; generating a cleaning signal when the contamination degree detected through a sensor exceeds a predetermined reference value; and in response to the generation of the cleaning signal, injecting cleaning liquid and compressed air through a cleaning nozzle device to a passage of laser pulses on the LiDAR surface.

The generating of the cleaning signal may include classifying the contamination degree of the LiDAR surface into a plurality of different contamination degrees according to a ratio of a laser point having a distance value less than or equal to a predetermined distance value among the laser points for one cycle of the LiDAR.

The cleaning operation may include a cleaning operation using only the compressed air when the contamination degree is a first contamination degree; a cleaning operation using only the cleaning liquid when the contamination degree is a second contamination degree higher than the first contamination degree; and a cleaning operation using both the cleaning liquid and the compressed air when the contamination degree is a third contamination degree higher than the second contamination degree.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating the exterior of a vehicle in one form of the present disclosure;

FIG. 2 is a view illustrating a cleaning nozzle device for cleaning Light Detection and Ranging (LiDAR) of a vehicle in one form of the present disclosure;

FIG. 3 is a view illustrating a structure of a cleaning nozzle device of a vehicle in one form of the present disclosure;

FIG. 4 is a view illustrating a state in which cleaning liquid is injected from a cleaning nozzle device of a vehicle in one form of the present disclosure;

FIG. 5 is a view illustrating a state in which compressed air is injected from a cleaning nozzle device of a vehicle in one form of the present disclosure;

FIG. 6 is a view illustrating a control system of a vehicle in one form of the present disclosure; and

FIG. 7 is a view illustrating a method of controlling a vehicle in one form of the present disclosure.

The drawings described herein are for illustration purposes only and are not intended to limit the scope of the present disclosure in any way.

### DETAILED DESCRIPTION

The following description is a merely exemplary in nature and is not intended to limit the present disclosure, application, or uses. It should be understood that throughout the drawings, corresponding reference numerals indicate like or corresponding parts and features.

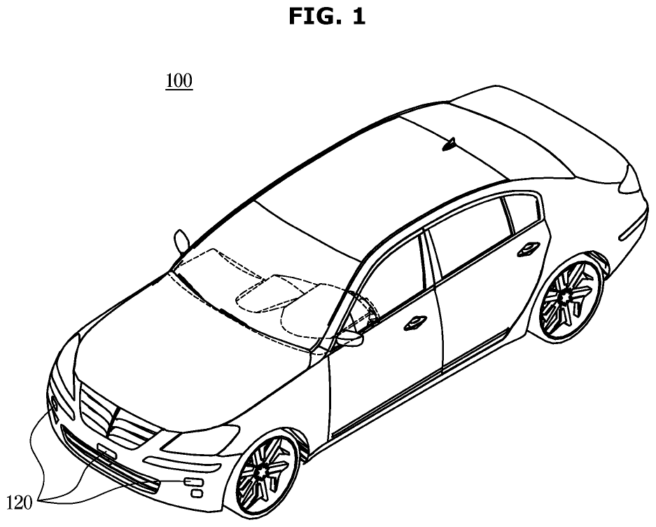

FIG. 1 is a view illustrating the exterior of a vehicle according to forms of the disclosure.

As illustrated in FIG. 1, Light Detection and Ranging (LiDAR) 120 may be mounted on a front surface of a vehicle 100 (particularly, at both ends of a front bumper).

The LiDAR 120 may be a device that emits a laser pulse, and receives the laser pulse reflected from a surrounding object to measure a distance to the object, thereby precisely scanning the surroundings. The LiDAR 102 may be used not only for detecting the distance to the target object but also for detecting a moving speed and a direction of the object.

The LiDAR 120 may be a core technology of sensors that obtain information necessary to implement a three-dimensional (3D) image. As illustrated in FIG. 1, when the LiDAR 120 is mounted on the vehicle 100 and the object and a terrain around the vehicle 100 are detected by analyzing a spatial position of a reflection point by measuring a time of returning the laser pulse to the periphery of the vehicle 100 while the vehicle 100 is driving, the reflected and returned time differs depending on the object and the terrain, so that it is possible to obtain a three-dimensional (3D) model that is difficult to obtain from an optical image. The LiDAR 120 of the vehicle 100 may also combine GPS position coordinates to obtain the precise spatial information of the surroundings.

The LiDAR 120 may include a laser, a scanner, a receiver, and a positioning system. The laser may have different wavelengths depending on the application, and may usually use light with a wavelength of 600-1000 nm. However, it may also use longer wavelengths of light to reduce damage to human eyes. The scanner is a part that quickly scans the surroundings to obtain information. Various types of mirrors may be used for this purpose. The receiver is a part that detects the returning light, and a sensitivity of the receiver to the light is the main factor that determines the performance of the LiDAR 120. Fundamentally, the receiver may detect photons and amplify the photons. The positioning system may identify the position coordinates and direction of the receiver in order to implement the 3D image.

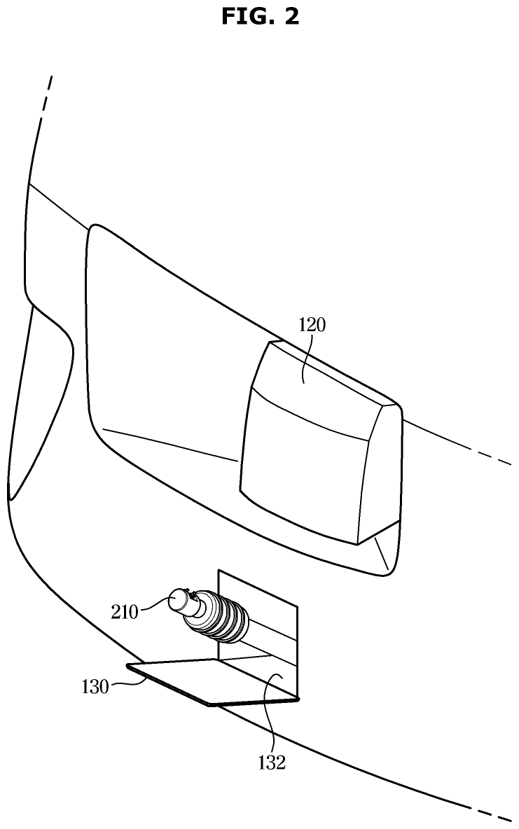

FIG. 2 is a view illustrating a cleaning nozzle device for cleaning Light Detection and Ranging (LiDAR) of a vehicle in some forms of the present disclosure.

A cleaning nozzle device 210 may be a device for cleaning and removing contamination on the surface of the LiDAR 120. In the cleaning nozzle device 210 of the vehicle 100, cleaning liquid and compressed air for cleaning the contamination on the surface of the LiDAR 120 may be injected.

The LiDAR 120 may emit the laser pulse, and receive the laser pulse reflected from the surrounding object to measure the distance to the object. Therefore, a window for protecting laser generating means may be provided in the LiDAR 120, and the emitted laser pulse or the reflected and returned laser pulse may pass through the window. When the window (surface) of the LiDAR 120 is contaminated with dust or muddy water, the laser pulse will not pass through properly, and the LiDAR 120 may not operate normally. That is, the contamination of the surface of the LiDAR 120 may refer to foreign substances that are deposited on the surface of the LiDAR 120, thereby preventing passage of the laser pulse.

As illustrated in FIG. 2, the cleaning nozzle device 210 is mounted under the LiDAR 120 on the front bumper of the vehicle 100. The cleaning nozzle device 210 may be provided in a storage chamber 132 that is opened and closed by a cover 130. That is, when the cleaning nozzle device 210 is not operated, the cleaning nozzle device 210 may be housed in the storage chamber 132 and the cover 130 may remain closed.

When the cleaning nozzle device 210 is operated, the cover 130 of the storage chamber 132 may be opened and the cleaning nozzle device 210 may protrude forward from the storage chamber 132. In the protruded cleaning nozzle device 210, the cleaning liquid and the compressed air for cleaning the contamination on the surface of the LiDAR 120 may be injected.

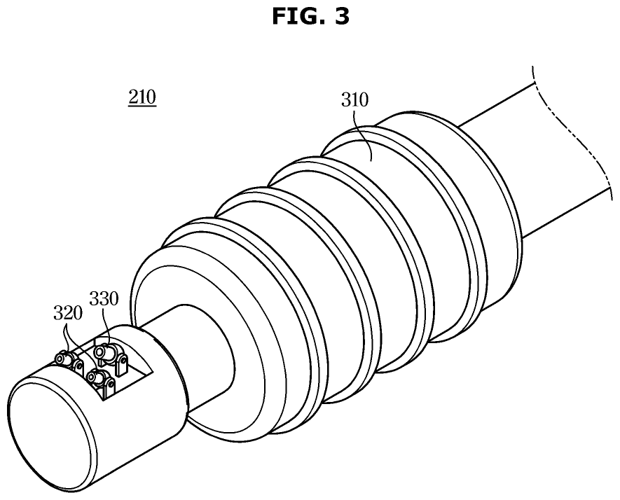

FIG. 3 is a view illustrating a structure of a cleaning nozzle device of a vehicle in some forms of the present disclosure.

As illustrated in FIG. 3, three nozzles 320 and 330 may be formed at the end of the cleaning nozzle device 210. The cleaning liquid injection nozzles 320 may be formed as a pair, and the cleaning liquid for cleaning the surface of the LiDAR 120 may be injected through the cleaning liquid injection nozzles 320. The compressed air injection nozzle 330 may be composed of a single nozzle, and the compressed air for cleaning the surface of the LiDAR 120 may be injected through the compressed air injection nozzle 330.

The cleaning liquid injection nozzles 320 do not necessarily have to be formed as the pair, but may be composed of a single nozzle or three or more nozzles. The compressed air injection nozzle 330 does not necessarily have to be the single nozzle, but may be composed of two or more nozzles.

The cleaning liquid injection nozzles 320 and the compressed air injection nozzle 330 may be supported by a support member 310. The support member 310 may be retracted and deployed by a separate transmission device (not shown) to be housed in the storage chamber 132 or protrude out of the storage chamber 132 while mechanically supporting the cleaning liquid injection nozzles 320 and the compressed air injection nozzle 330. A piping (not shown) connected to the cleaning liquid injection nozzles 320 and the compressed air injection nozzle 330 may be accommodated in the support member 310. The cleaning liquid and the compressed air may be delivered to the cleaning liquid injection nozzles 320 and the compressed air injection nozzle 330 through the piping inside the support member 310, and may be injected through the cleaning liquid injection nozzles 320 and the compressed air injection nozzle 330.

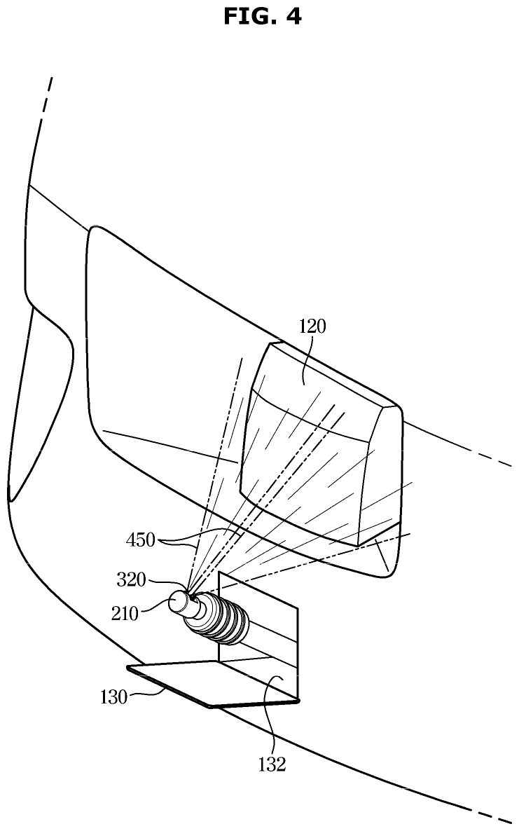

FIG. 4 is a view illustrating a state in which cleaning liquid is injected from a cleaning nozzle device of a vehicle in some forms of the present disclosure.

As illustrated in FIG. 4, cleaning liquid 450 may be injected from the pair of cleaning liquid injection nozzles 320 to remove the contamination on the surface of the LiDAR 120. When the surface of the LiDAR 120 is adhered with contaminants such as dust or mud, it is difficult to remove the contamination by compressed air only. Accordingly, the cleaning liquid 450 may be injected through the cleaning liquid injection nozzles 320 to effectively remove the dust or mud adhering to the surface of the LiDAR 120.

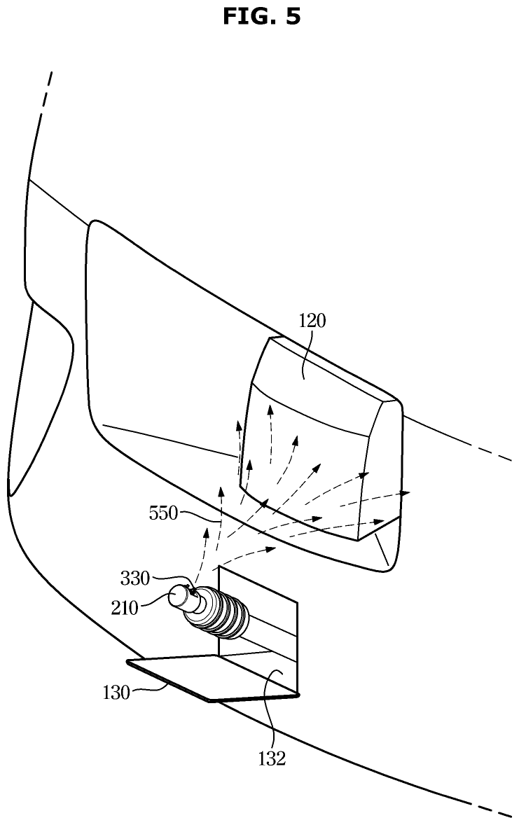

FIG. 5 is a view illustrating a state in which compressed air is injected from a cleaning nozzle device of a vehicle in some forms of the present disclosure.

As illustrated in FIG. 5, compressed air 550 may be injected in the single compressed air injection nozzle 330 to remove the contamination on the surface of the LiDAR 120. When the surface of the LiDAR 120 is filled with non-adhering contaminants such as dust, it is possible to remove the contamination by compressed air only. Accordingly, the compressed air 550 may be injected through the compressed air injection nozzle 330 to effectively remove the dust and the like that have not been adhered on the surface of the LiDAR 120.

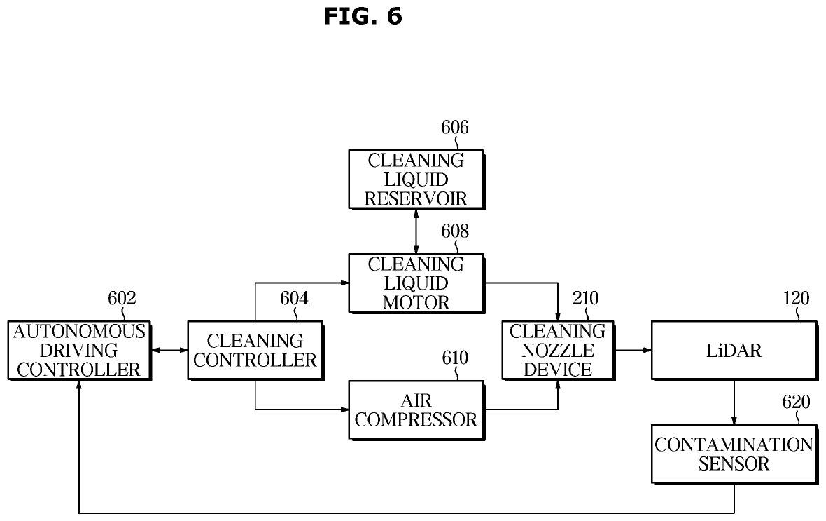

The compressed air 550 may be used virtually indefinitely because it uses air around the vehicle 100. In contrast, since the cleaning liquid 450 stores and uses the cleaning liquid in a cleaning liquid reservoir 606 (see FIG. 6) of the vehicle 100, the frequent use of the cleaning liquid 450 may be complicated to fill the cleaning liquid reservoir 606 frequently. In the case of a low contamination degree where the cleaning liquid 450, which is relatively cumbersome to manage, is not needed, the compressed air 550, which is relatively easy to manage, may be used. Therefore, when the compressed air 550 is used together with the cleaning liquid 450 for cleaning the surface of the LiDAR 120, the vehicle 100 may be more conveniently and cleanly maintained.

FIG. 4 illustrates the injecting of the cleaning liquid 450, and FIG. 5 illustrates the injecting of the compressed air 550. In this way, only the cleaning liquid 450 or the compressed air 550 may be injected alone to remove the contamination, but the cleaning liquid 450 and the compressed air 550 may be combined to further enhance the cleaning effect, if necessary.

For example, when the cleaning liquid 450 is injected to remove the adhesion of the contaminants, the compressed air 550 may be injected thereon to remove the contaminants on the surface of the LiDAR 120.

Alternatively, for example, the compressed air 550 may be injected on the surface of the LiDAR 120 to remove the dust and the like, and then the cleaning liquid 450 may be injected thereon. If necessary, the surface of the LiDAR 120 may be further cleaned by injecting the compressed air 550 again thereon and evaporating the cleaning liquid 450.

Alternatively, the surface of the LiDAR 120 may be cleaned, for example, by simultaneously injecting the cleaning liquid 450 and the compressed air 550 on the surface of the LiDAR 120.

FIG. 6 is a view illustrating a control system of a vehicle in some forms of the present disclosure. Particularly, FIG. 6 illustrates a control system for driving and controlling the cleaning nozzle device 210 for removing the contamination of the LiDAR 120.

As illustrated in FIG. 6, a cleaning controller 604 may receive a cleaning signal generated from an autonomous driving controller 602 of the vehicle 100 and control the cleaning nozzle device 210 in response to the received cleaning signal. That is, the autonomous driving controller 602 may detect the contamination degree on the surface of the LiDAR 120 through a sensor 620. When the detected contamination degree exceeds a predetermined reference value, the autonomous driving controller 602 may determine that a cleaning operation of the LiDAR 120 is necessary, generate the cleaning signal, and transmit the cleaning signal to the cleaning controller 604. The cleaning controller 604 may operate a cleaning liquid motor 608 or an air compressor 610 in response to the cleaning signal generated from the autonomous driving controller 602 to cause the cleaning liquid 450 or the compressed air 550 to be injected through the cleaning nozzle device 210.

The cleaning controller 604 may operate the cleaning liquid motor 608 and the air compressor 610 for the cleaning operation of the LiDAR 120. The cleaning liquid motor 608 may supply the cleaning liquid stored in the cleaning liquid reservoir 606 to the cleaning nozzle device 210 so that the cleaning liquid is injected on the surface of the LiDAR 120 through the cleaning nozzle device 210. The air compressor 610 may compress the air and supply the compressed air to the cleaning nozzle device 210 so that the compressed air is injected on the surface of the LiDAR 120 through the cleaning nozzle device 210.

The cleaning controller 604 may independently determine whether to perform cleaning of the LiDAR 120 every predetermined cycle of the LiDAR 120 or whenever a predetermined cleaning condition is satisfied regardless of the cleaning signal of the autonomous driving controller 602, and may perform the cleaning of the LiDAR 120.

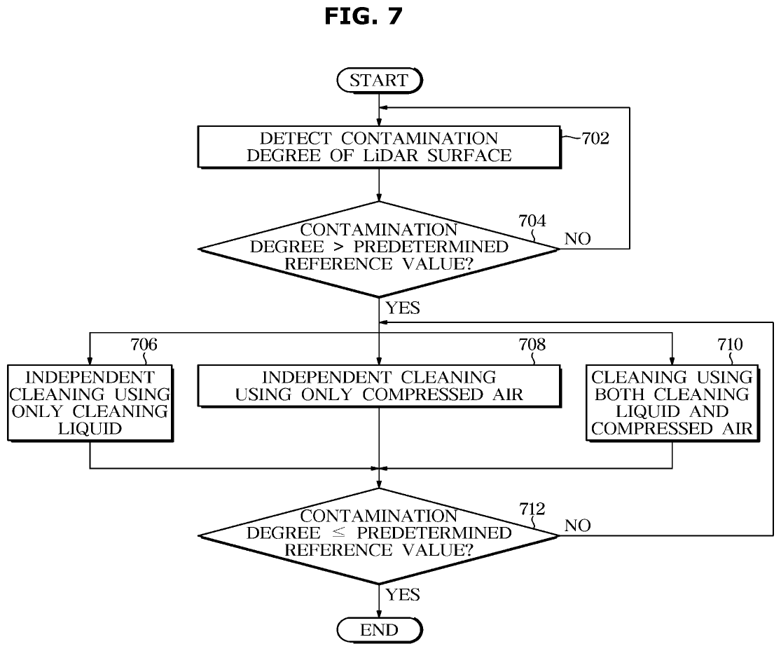

FIG. 7 is a view illustrating a method of controlling a vehicle in some forms of the present disclosure.

The autonomous driving controller 602 may detect the contamination degree of the LiDAR surface through the sensor 620 (702). The LiDAR 120 may be a point cloud based sensor. That is, the LiDAR 120 may scan a plurality of laser points in a predetermined direction with a laser pointer, and grasp the shape and distance position of the surrounding object as information on the direction and distance of each of the plurality of laser points. When the number of points whose distance value within a predetermined distance (for example, 10 cm) among the points during one cycle of the LiDAR 120 is more than a predetermined number, the autonomous driving controller 602 may determine that the surface of the LiDAR 120 is contaminated. In addition, the autonomous driving controller 602 may determine the contamination degree according to the ratio of points within the distance of 10 cm among the points of one cycle of the LiDAR 120. For example, when the ratio of points within 10 cm of the distance value is less than 10% at all the points, the autonomous driving controller 602 may determine that the contamination degree is at a first level. When the ratio of points within 10 cm of the distance value is more than 10% and less than 30% at all the points, the autonomous driving controller 602 may determine that the contamination degree is at the first level. In this way, the autonomous driving controller 602 may discriminate the contamination degree by various levels such as a first contamination degree, a second contamination degree, and a third contamination degree.

When the detected contamination degree is greater than the predetermined reference value (YES in 704), the autonomous driving controller 602 may determine that the cleaning operation of the LiDAR 120 is necessary, generate the cleaning signal, and transmit the cleaning signal to the cleaning controller 604 so that the cleaning operation using the cleaning liquid or the compressed air can be performed. The cleaning controller 604 may operate the cleaning liquid motor 608 or the air compressor 610 in response to the cleaning signal generated from the autonomous driving controller 602 to cause the cleaning liquid 450 or the compressed air 550 to be injected through the cleaning nozzle device 210.

The cleaning operation under the control of the cleaning controller 604 may be classified according to the determined contamination degree as follows. That is, when the contamination degree of the surface of the LiDAR 120 is determined to be the first contamination degree, the cleaning controller 604 may perform independent cleaning using only the compressed air (708). Since the first contamination degree is a relatively low contamination degree, the cleaning controller 604 may reduce the use of the cleaning liquid by performing the cleaning using only compressed air. When the contamination degree of the surface of the LiDAR 120 is determined to be the second contamination, which is higher than the first contamination degree, the cleaning controller 604 may perform the independent cleaning using only the cleaning liquid (706). Since the second contamination degree is higher than the first contamination degree, the compressed air alone may be insufficient. In this case, it is preferable to perform the independent cleaning using the cleaning liquid. When the contamination degree of the surface of the LiDAR 120 is determined to be the third contamination, which is higher than the second contamination degree, the cleaning controller 604 may perform the cleaning using both the cleaning liquid and the compressed air (710). Since the third contamination degree is higher than the second contamination degree, the cleaning liquid air alone may be insufficient. In this case, it is preferable to perform the cleaning using both the cleaning liquid and the compressed air.

That is, the independent cleaning using the cleaning liquid may be performed under the control of the cleaning controller 604 (706). That is, the cleaning controller 604 may operate the cleaning liquid motor 608 for the cleaning operation of the LiDAR 120 to supply the cleaning liquid stored in the cleaning liquid reservoir 606 to the cleaning nozzle device 210 so that the cleaning liquid is injected on the surface of the LiDAR 120 through the cleaning nozzle device 210.

In addition, the independent cleaning using the compressed air may be performed under the control of the cleaning controller 604 (708). That is, the cleaning controller 604 may operate the air compressor 610 for the cleaning operation of the LiDAR 120 to supply the compressed air to the cleaning nozzle device 210 so that the compressed air is injected on the surface of the LiDAR 120 through the cleaning nozzle device 210.

Also, the cleaning using both the cleaning liquid and the compressed air may be performed under the control of the cleaning controller 604 (710). That is, the cleaning controller 604 may perform the cleaning using the cleaning liquid described in operation 706 and the cleaning using the compressed air described in operation 708 for the cleaning operation of the LiDAR 120.

When the cleaning for removing the contamination of the surface of the LiDAR 120 is completed, the autonomous driving controller 602 may detect the contamination degree of the surface of the LiDAR 120 once more. When the contamination degree of the surface of the LiDAR 120 is lower than the reference value (YES in 712), the autonomous driving controller 602 may terminate the cleaning operation. On the other hand, when the contamination degree of the surface of the LiDAR 120 still exceeds the reference value (NO in 712), the autonomous driving controller 602 may repeat at least one of the cleaning operations of operations 706, 708, and 710.

As is apparent from the above description, in some forms of the present disclosure, the contamination of the LiDAR surface mounted on the vehicle can be removed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle comprising:
Light Detection and Ranging (LiDAR) configured to detect an object and a terrain around the vehicle; and
a cleaning nozzle device configured to inject cleaning liquid and compressed air on a LiDAR surface to a passage of laser pulses on the LiDAR surface.

2. The vehicle of claim 1, wherein the cleaning nozzle device further comprises:
a cleaning liquid nozzle configured to inject the cleaning liquid on the LiDAR surface; and
a compressed air nozzle configured to inject the compressed air on the LiDAR surface.

3. The vehicle of claim 1, wherein the vehicle further comprises:
a sensor configured to detect a contamination degree of the LiDAR surface.

4. The vehicle of claim 3, wherein the vehicle further comprises:
a controller configured to perform a cleaning operation of the LiDAR surface by generating a cleaning signal when the contamination degree exceeds a predetermined reference value.

5. The vehicle of claim 4, wherein the controller is configured to:
classify the contamination degree of the LiDAR surface into different contamination degrees based on a ratio of a laser point having a distance value less than or equal to a predetermined distance value among the laser points for one cycle of the LiDAR.

6. The vehicle of claim 5, wherein, when performing the cleaning operation, the controller is configured to:
use only the compressed air when the contamination degree is a first contamination degree;
use only the cleaning liquid when the contamination degree is a second contamination degree that is higher than the first contamination degree; and
use both the cleaning liquid and the compressed air when the contamination degree is a third contamination degree that is higher than the second contamination degree.

7. A method of controlling a vehicle comprising:
detecting, by a Light Detection and Ranging (LiDAR), an object and a terrain around the vehicle; and
injecting, by a cleaning nozzle device, cleaning liquid and compressed air on a LiDAR surface to a passage of laser pulses on the LiDAR surface.

8. The method of claim 7, wherein injecting the cleaning liquid and the compressed air comprises:
injecting, by a cleaning liquid nozzle, the cleaning liquid on the LiDAR surface; and
injecting, by a compressed air nozzle, the compressed air on the LiDAR surface.

9. The method of claim 7, wherein the method further comprises:
detecting, by a sensor, a contamination degree of the LiDAR surface.

10. The method of claim 9, wherein the method further comprises:
when the contamination degree exceeds a predetermined reference value, performing, by a controller, a cleaning operation of the LiDAR surface by generating a cleaning signal.

11. The method of claim 10, wherein the method comprises:
classifying, by the controller, the contamination degree of the LiDAR surface into different contamination degrees based on a ratio of a laser point having a distance value less than or equal to a predetermined distance value among the laser points for one cycle of the LiDAR.

12. The method of claim 11, wherein performing the cleaning operation comprises:
when the contamination degree exceeds a predetermined reference value, using only the compressed air when the contamination degree is a first contamination degree;
when the contamination degree is a second contamination degree that is higher than the first contamination degree, using only the cleaning liquid; and
when the contamination degree is a third contamination degree that is higher than the second contamination degree, using both the cleaning liquid and the compressed air.

13. A vehicle comprising:
Light Detection and Ranging (LiDAR) configured to detect an object and a terrain around the vehicle;
a cleaning nozzle device configured to inject cleaning liquid by a cleaning liquid nozzle on a LiDAR surface and compressed air by a compressed air nozzle on the LiDAR surface to a passage of laser pulses on the LiDAR surface, wherein the cleaning nozzle device comprises the cleaning liquid nozzle and the compressed air nozzle;
a cleaning liquid reservoir configured to store the cleaning liquid;
a cleaning liquid motor configured to supply the cleaning liquid to the cleaning liquid nozzle;
an air compressor configured to compress air to generate the compressed air;
a sensor configured to detect a contamination degree of the LiDAR surface; and
a controller configured to generate a cleaning signal to perform a cleaning operation of the LiDAR surface when the contamination degree exceeds a predetermined reference value.

14. The vehicle of claim 13, wherein the controller is configured to classify the contamination degree of the LiDAR surface into different contamination degrees based on a ratio of a laser point having a distance value less than or equal to a predetermined distance value among the laser points for one cycle of the LiDAR.

15. The vehicle of claim 14, wherein, when performing the cleaning operation, the controller is configured to:
use only the compressed air when the contamination degree is a first contamination degree;
use only the cleaning liquid when the contamination degree is a second contamination degree that is higher than the first contamination degree; and
use both the cleaning liquid and the compressed air when the contamination degree is a third contamination degree that is higher than the second contamination degree.

16. A method of controlling a vehicle comprising:
detecting, by Light Detection and Ranging (LiDAR), an object and a terrain around the vehicle;
detecting, by a sensor, a contamination degree of a LiDAR surface;
generating, by a controller, a cleaning signal when the contamination degree exceeds a predetermined reference value; and
injecting, by a cleaning nozzle device, cleaning liquid and compressed air on the LiDAR surface to a passage of laser pulses on the LiDAR surface.

17. The method of claim 16, wherein generating the cleaning signal comprises:
classifying the contamination degree of the LiDAR surface into different contamination degrees based on a ratio of a laser point having a distance value less than or equal to a predetermined distance value among the laser points for one cycle of the LiDAR.

18. The method of claim 17, wherein the method comprises:
performing, by a controller, a cleaning operation using only the compressed air when the contamination degree is a first contamination degree;
performing, by the controller, the cleaning operation using only the cleaning liquid when the contamination degree is a second contamination degree that is higher than the first contamination degree; and
performing, by the controller, the cleaning operation using both the cleaning liquid and the compressed air when the contamination degree is a third contamination degree that is higher than the second contamination degree.
